(19) United States
(12) Patent Application Publication
(10) Pub. No.: US 2007/0093084 A1
(43) Pub. Date: Apr. 26, 2007

(54) Method for manufacturing antipressure linear circuit board and circuit board manufactured therefrom

(75) Inventor: Chin-Jung Chen, Taipei (TW)

Correspondence Address: HDSL, 4331 STEVENS BATTLE LANE, FAIRFAX, VA, 22033, US

(73) Assignee: Rossmax International Ltd.

(21) Appl. No.: 11/254,911

(22) Filed: Oct. 21, 2005

(51) Int. Cl. H01R 12/00

(52) U.S. Cl. 439/74

(57) ABSTRACT

A method for manufacturing an anti-pressure linear circuit board includes the following steps. First, a first circuit board is provided. The first circuit board is cut to form cut grooves. The cut grooves define a second circuit board, which is electrically connected with the first circuit board. A precisely calibrated pressure sensor and an OP amplifier are disposed on the second circuit board. Meanwhile, the second circuit board is electrically connected with the first circuit board that includes is learning point. Thus, the manufacturing process of the anti-pressure linear circuit board is completed. This anti-pressure linear circuit board can reduce the effect of pressure on the reading precision of the pressure sensor and the OP amplifier.

### BACKGROUND OF THE INVENTION

The present invention relates generally to a method for manufacturing a circuit board and the circuit board manufactured therefrom. More particularly, the present invention relates to a method for manufacturing an anti-pressure linear circuit board and the circuit board manufactured therefrom.

As shown in FIG. 1, the method for manufacturing a circuit board that has a pressure sensor and an amplifier circuit disposed thereon, includes the following steps. First, an electronic passive element 11 is inserted on to a circuit board 1, and a precisely pre-calibrated pressure sensor 12 and OP amplifier 13 are disposed on the circuit board 1 electrically connecting with each other. The circuit board 1 is further screwed onto the case of an electronic product (not shown). Then, a learning process and a calibration process is performed on the circuit board, allowing the central controller 10 to learn the transmission and measurement of pressure. In addition, a probe needle is used to further enhance the reading precision of the microchip. However, during the probing process, an external force is applied to the circuit board 1. The external force can be the screw assembly, the downward pressure from the atmosphere, or the probing pressure from the probe needle. All these external forces can slightly deform the circuit board 1, thereby changing the configured values and the pressure readings. This will directly affect the stored value after the learning process. Even worse, the learning function of pressure comparison may not be completed, which will lower the process yield and increase the process cost.

In addition, one possible solution to the conventional process described above is that the main circuit is disposed on a separate circuit board other than that of the pressure sensor and the OP amplifier. The circuit boards are then electrically connected with each other. Although this method can prevent the pressure sensor and the OP amplifier from being pressed or deformed at the programming station and the calibration station, however, this configuration requires at least two circuit boards, thus doubling the cost. Alternatively, one can employ a metallic shell to cover the pressure sensor and the OP amplifier on the circuit board. However, this method can not reduce the deformation in response to the applied pressure. Moreover, the reading precision of the pressure sensor and the OP amplifier is not enhanced, either.

### BRIEF SUMMARY OF THE INVENTION

It is an object of the present invention to provide a method for manufacturing an anti-pressure linear circuit board and the article manufactured therefrom. The first circuit board of the present invention is cut to form a cut groove during a cutting process, so as to form a second circuit board. The deformation of the first circuit board due to the external forces will not affect the precision of the pressure sensor and the OP amplifier. Therefore, the negatives effects of external force and pressure during the learning and the calibration process will be reduced. Meanwhile, the rework rate is reduced while the yield is increased.

In order to achieve the above and other objectives, the method of the present invention includes the steps of:

providing a first circuit board;

cutting the first circuit board to form a cut groove, the cut groove defining a second circuit board;

calibrating the pressure sensor and the OP amplifier; and

disposing the calibrated pressure sensor and OP amplifier on the second circuit board.

In order to achieve the above and other objectives, the anti-pressure linear circuit board of the present invention includes a first circuit board, which includes a cut groove, and a second circuit defined by the cut groove. The second circuit board is electrically connected to the first circuit board. The second circuit board includes a pressure sensor and an OP amplifier.

### BRIEF DESCRIPTION OF THE DRAWINGS

FIG. 1 illustrates a conventional circuit board.

FIG. 2 illustrates a flow diagram, in accordance with one embodiment of the present invention.

FIG. 3 is a perspective view illustrating a circuit board, in accordance with one embodiment of the present invention.

FIG. 4 is a top view illustrating a circuit board, in accordance with one embodiment of the present invention.

FIG. 5 is a partial section view illustrating a circuit board, in accordance with one embodiment of the present invention.

FIG. 6 is a top view illustrating a circuit board, in accordance with another embodiment of the present invention.

FIG. 7 is a flow diagram illustrating the method for manufacturing an electronic blood pressure meter.

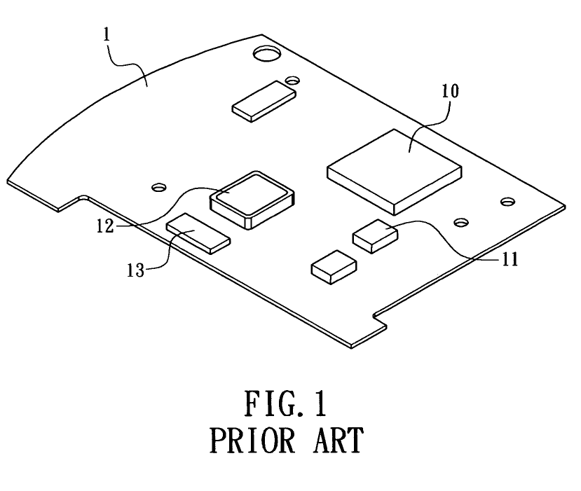

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

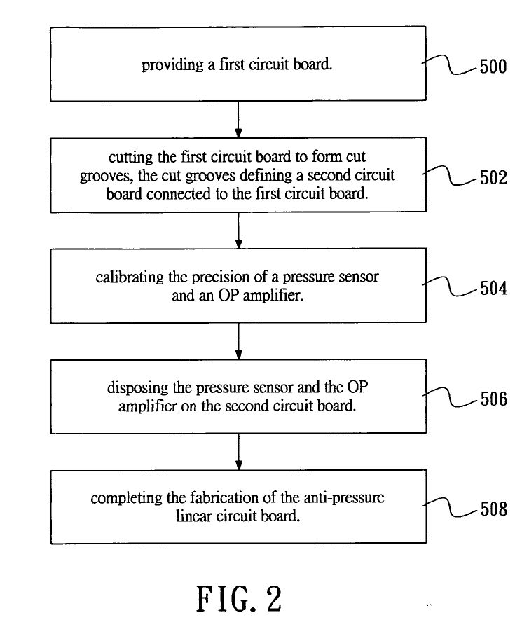

Referring to FIG. 2, a flow diagram illustrating a method for manufacturing an anti-pressure linear circuit board is provided. As shown, the method includes the following steps.

First, manufacturing a first circuit board:

In step 500, a first circuit board 2 is provided.

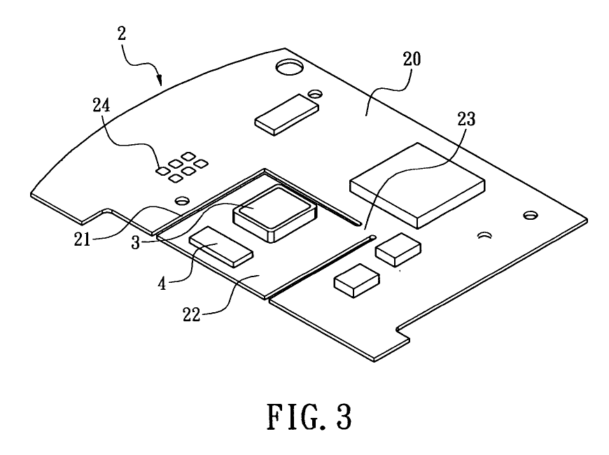

In step 502, a cut groove 21 (see FIG. 3) is formed on the first circuit board 2. A second circuit board 22 is defined around the cut groove 21. Meanwhile, a connection portion 23 is formed for connecting to the first circuit board 2. The connection portion 23 is slightly flexible. Printed circuits for electrically connecting the main circuit 20 and the learning points 24 are formed on the first circuit board 2. The second circuit board 22 includes circuits for connecting the pressure sensor 3 and the OP amplifier 4. Or, the second circuit board 22 includes the printed circuits for connecting the pressure sensor 3 and the OP amplifier 4, and the calibration points (not shown).

The formation and calibration of the pressure sensor and the OP amplifier:

In step 504, the precision of the pressure sensor 3 and the OP amplifier 4 are pre-calibrated and are set to their default precision configurations.

In step 506, the pre-calibrated pressure sensor 3 and the OP amplifier 4 (or one of the above) are electrically connected to the printed circuits of the second circuit board 21.

In step 508, the manufacturing process of the anti-pressure linear circuit board is completed.

In the manufacturing process described above, the pressure sensor 3 and the OP amplifier 4 disposed on the second circuit board 21 are electrically connected to the main circuit 20 of the first circuit board 2 via the printed circuits on the connection portion 23.

Since the second circuit board 21 and the first circuit board 2 are electrically connected only via the connection portion 23, the second circuit board 23 can maintain its original position without being deformed or pressed due to the flexibility of the connection portion 23, especially when the first circuit board 2 is installed on the case of an electronic product, or when the first circuit board 2 is under the learning or probing procedure at the learning station or the calibration station. Therefore, the precision of pressure calibration and the manufacturing yield are both enhanced.

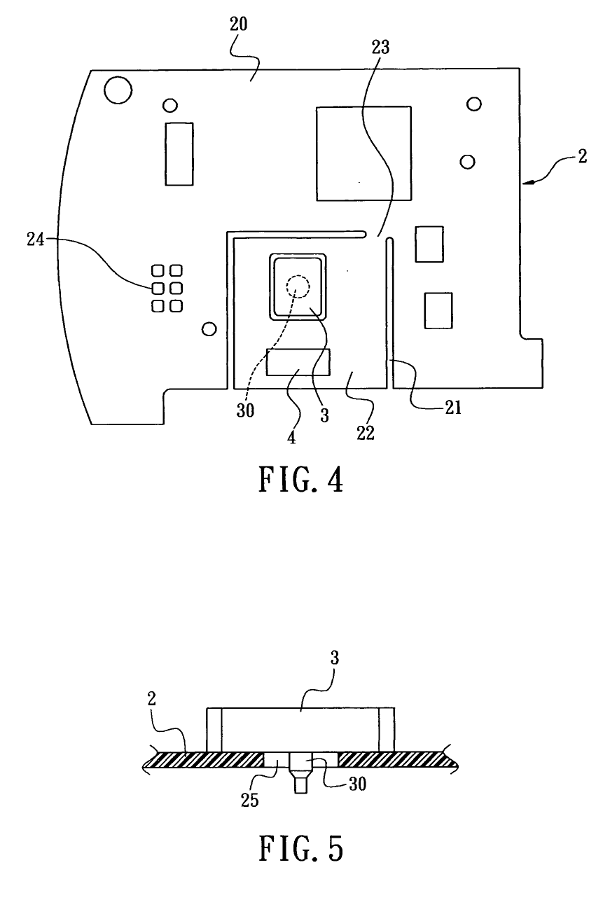

Referring to FIG. 3, FIG. 4 and FIG. 5, the anti-pressure linear circuit board of the present invention is illustrated. As shown, the anti-pressure linear circuit board includes a first circuit board 2. At least a cut groove 21 is formed on the first circuit board 2. A second circuit board 22 is defined according to the cut groove 21, the second circuit board 22 being connected to the first circuit board via the connection portion 23. At least a pressure sensor 3 and a OP amplifier 4 is electrically connected to the second circuit board 22. The pressure sensor 3 further includes a pressure sensing tip 30 penetrated through a hole 25 formed on the second circuit 22 for detecting the pressure.

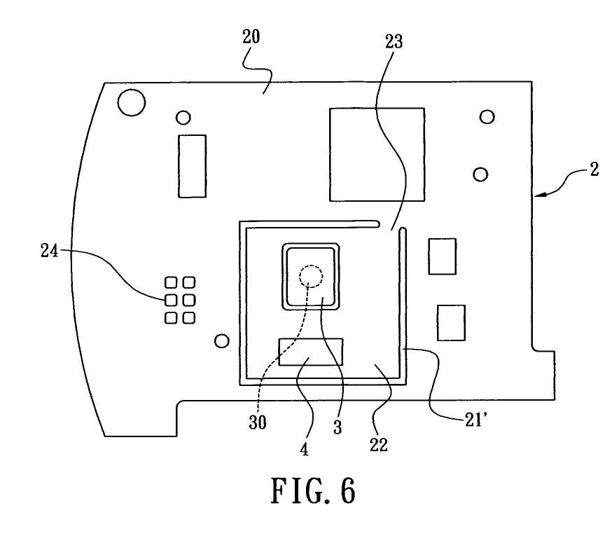

Referring to FIG. 6, an anti-pressure linear circuit board, in accordance with another embodiment of the present invention, is illustrated. As shown, the anti-pressure linear circuit board of this particular embodiment is similar to that shown in FIG. 3, FIG. 4 and FIG. 5. The difference is in that a four-sided cut groove 21′ is formed on the first circuit board 2, which includes the pressure sensor 3 and the OP amplifier 4 disposed thereon. The second circuit board 22 is defined according to the four-sided cut groove 21′ within the first circuit board 2. The second circuit board 22 is electrically connected with the first circuit board 2 via the connection portion 23. Similar to the first embodiment, the second circuit board 22 will not be affected or deformed in response to the pressure exerted on the first circuit board 2. This can effectively reduce the effect of the external force and the probing pressures, decrease the rework rate, and increase the manufacturing yield. An anti-pressure linear circuit board of higher precision is thus produced without increasing the cost.

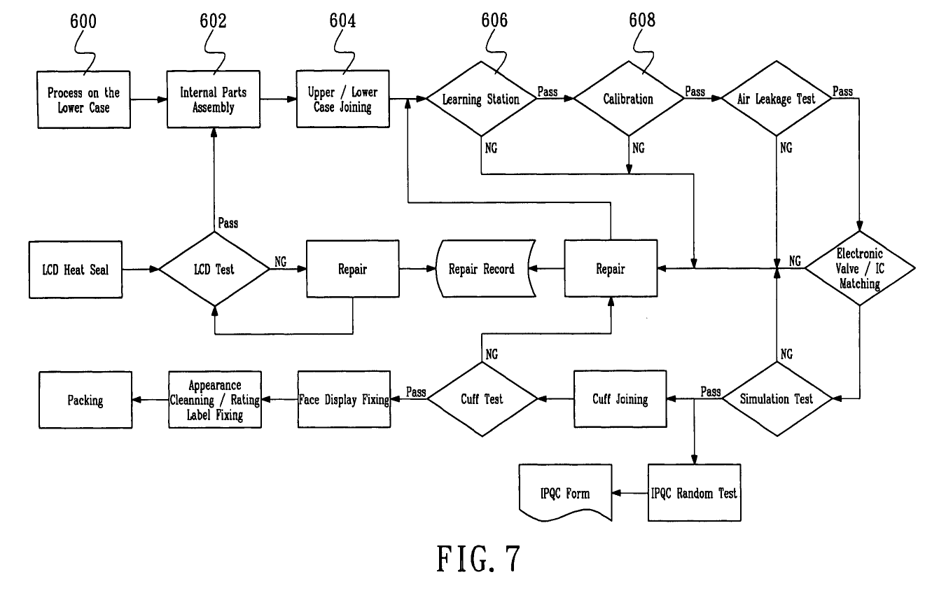

Referring to FIG. 7, a flow diagram illustrating the method for manufacturing the anti-pressure linear circuit board of the present invention is provided. The linear circuit board is applied to the circuit board of an electronic blood pressure meter. As shown, after the process on the lower case, as in step 600, a first circuit board 2 and a second circuit board 22 is produced to form an electronic blood pressure circuit board. The first circuit board 2 includes a main control circuit of the electronic blood pressure meter and a LCD monitor. The second circuit board 22 includes a precisely calibrated pressure sensor 3 and an OP amplifier 4, or only one of the above, so as to assemble the internal part of the electronic blood pressure meter, as in step 602. Then proceed to the assembly process of upper and lower case, as in step 604.

Next, in step 606, the blood pressure meter learns about atmospheric pressure by using the learning point 24 on the first circuit board 2 in the learning station. The analog values of pressure is then converted to digital values and stored in the micro control unit (MCU). Then, in step 608, a pressure measurement is performed via a probe needle.

Since the pressure sensor 3 and the OP amplifier 4 is disposed on the second circuit board 22, they will not be affected by the examine pressure applied to the first circuit board at the learning station and the calibration station. Therefore, the defective process in the learning station and the calibration station is improved, which will reduce the rework rate and decrease the cost of reworks.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A method for manufacturing an anti-pressure linear circuit board, which comprises the steps of:
a) providing a first circuit board; and
b) cutting the first circuit board to form cut grooves, which defines the second circuit board, the second circuit board being connected to the first circuit board via a connection portion.

2. The method as recited in claim 1, wherein the first circuit board includes a main circuit.

3. The method as recited in claim 1, wherein the second board includes a calibrated pressure sensor and an OP amplifier.

4. The method as recited in claim 1, further comprising: precisely calibrating the pressure sensor and the OP amplifier.

5. The method as recited in claim 1, wherein the main circuit on the first circuit board is electrically connected to the pressure sensor and the OP amplifier on the second circuit board via printed circuits on the connection portion.

6. A method for manufacturing an anti-pressure linear circuit board, comprising:
a) providing a first circuit board;
b) cutting the first circuit board to form a cut groove, the cut groove defining a second circuit board, the first circuit board and the second circuit board being connected via a connection portion;
c) disposing a main circuit on the first circuit board;
d) disposing a calibrated pressure sensor or an OP amplifier on the second circuit board.

7. The method as recited in claim 6, further comprising disposing a pressure sensor or an OP amplifier, not being disposed on the second circuit board, on the first circuit board.

8. An anti-pressure linear circuit board, comprising:
a first circuit board including a cut groove; and
a second circuit board defined by the cut groove,
wherein the first circuit board and the second circuit board are connected via a connection portion.

9. The circuit board as recited in claim 8, wherein the first circuit board includes a main circuit.

10. The circuit board as recited in claim 8, wherein the first circuit board includes a main circuit and an OP amplifier.

11. The circuit board as recited in claim 8, wherein the first circuit board includes a main circuit and a pressure sensor.

12. The circuit board as recited in claim 8, wherein the second circuit board includes an OP amplifier and a pressure sensor.

13. The circuit board as recited in claim 8, wherein the second circuit board includes a pressure sensor or an OP amplifier.

14. The circuit board as recited in claim 8, wherein the connection portion comprises a printed circuit, which connects the first circuit board and the second circuit board.

15. The circuit board as recited in claim 8, further comprising a through hole on the second circuit board corresponding to the location of the pressure sensor.

16. The circuit board as recited in claim 8, wherein the pressure sensor further comprises a pressure detection tip penetrating through the hole formed on the second circuit board, thereby performing the pressure measurement.
